(19) United States
(12) Patent Application Publication
(10) Pub. No.: US 2022/0222902 A1
(43) Pub. Date: Jul. 14, 2022

(54) Remote Spatial Map Manipulation

(71) Applicant: ARKH, Inc., Dallas, TX (US)

(72) Inventors: Landon Nickerson, Dallas, TX (US); Sean Ong, Tukwila, WA (US); Preston McCauley, Dallas, TX (US)

(21) Appl. No.: 17/573,540

(22) Filed: Jan. 11, 2022

Related U.S. Application Data
(60) Provisional application No. 63/136,035, filed on Jan. 11, 2021.

(51) Int. Cl. G06T 19/00; G06T 17/20; G06T 15/10; G05D 1/00

(52) U.S. Cl. CPC G06T 19/006; G06T 17/20; G06T 2200/24; G05D 1/0044; G06T 15/10

(57) ABSTRACT

In some examples, an apparatus includes a memory storing computer executable instructions for implementing a spatially aware computing scheme and a processor coupled to the memory and configured to execute the executable instructions. Executing the executable instructions causes the processor to access a three-dimensional (3D) spatial map that comprises a plurality of meshes to form a 3D digital representation of a physical environment, display the 3D spatial map in a Bird's Eye View orientation, and receive a manipulation to the 3D spatial map while displaying the 3D spatial map in the Bird's Eye View orientation.

### CROSS-REFERENCE TO RELATED APPLICATIONS

This application claims priority to U.S. Provisional Application No. 63/136,035 filed Jan. 11, 2021 by Landon Nickerson, et al. entitled, “Remote Spatial Map Manipulation”, which is incorporated by reference herein as if reproduced in its entirety.

### BACKGROUND

Augmented reality (AR) technologies enable a merging of digital content and our physical environment. Through AR, digital content may be superimposed over our physical environment. Through AR, actions that we take in our physical environment may be processed digitally. Some technologies exist for placing digital content in a physical environment when viewed through a viewfinder, such as the screen of a smart device (e.g., smartphone, tablet, wearable device, etc.) in an AR session.

### SUMMARY

In some examples, an apparatus includes a memory storing computer executable instructions for implementing a spatially aware computing scheme and a processor coupled to the memory and configured to execute the executable instructions. Executing the executable instructions causes the processor to access a three-dimensional (3D) spatial map that comprises a plurality of meshes to form a 3D digital representation of a physical environment, display the 3D spatial map in a Bird's Eye View orientation, and receive a manipulation to the 3D spatial map while displaying the 3D spatial map in the Bird's Eye View orientation.

In some examples, an apparatus includes a memory storing computer executable instructions for implementing a spatially aware computing scheme and a processor coupled to the memory and configured to execute the executable instructions. Executing the executable instructions causes the processor to access a three-dimensional (3D) spatial map that comprises a plurality of meshes to form a 3D digital representation of a physical environment, display the 3D spatial map in a Bird's Eye View orientation, and display visual indicators in the 3D spatial map corresponding to positions of one or more user devices in the physical environment.

In some examples, an apparatus includes a memory storing computer executable instructions for implementing a spatially aware computing scheme and a processor coupled to the memory and configured to execute the executable instructions. Executing the executable instructions causes the processor to access a three-dimensional (3D) spatial map that comprises a plurality of meshes to form a 3D digital representation of a physical environment, display the 3D spatial map in a Bird's Eye View orientation, receive, via a user-input interface of the apparatus, a control input for a spatially-aware device represented in the 3D spatial map, and transmit the control input to control the spatially-aware device.

### BRIEF DESCRIPTION OF THE DRAWINGS

For a more complete understanding of this disclosure, reference is now made to the following brief description, taken in connection with the accompanying drawings and detailed description, wherein like block numerals represent like parts.

FIG. 1 is a block diagram of an example computing device in accordance with aspects of the disclosure.

FIG. 2 is a graphical user interface (GUI) representations of a Bird's Eye View of a three-dimensional (3D) spatial map in accordance with aspects of the disclosure.

FIG. 3 is a graphical user interface (GUI) representations of a Bird's Eye View of a three-dimensional (3D) spatial map in accordance with aspects of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Augmented reality (AR) technologies enable a merging of digital content and our physical environment. Through AR, digital content may be superimposed over our physical environment. Through AR, actions that we take in our physical environment may be processed digitally. To effectively create an AR environment in which digital content may be placed and/or interactions processed digitally, a map of a physical environment may be created. The map of the physical environment may be represented as a three-dimensional (3D) spatial map that includes mesh data. Sometimes, to view the 3D spatial map and/or interact with the mesh data, a user has to be located in the physical environment. This can create challenges in identifying gaps or missing areas in the mesh data. It can also make the placing and/or editing of digital content less efficient, such as by requiring a user to travel to different physical environments to interact with the 3D spatial map of each of the respective physical environments.

Disclosed herein is a spatial computing scheme in which a physical environment may be scanned and interacted with digitally to create an AR environment. The spatial computing scheme may be at least partially implemented through executable code that is cross-platform or cross-ecosystem compatible. For example, the executable code may be implemented as an application that is cross-platform compatible such that the application is not limited to any particular device model, device operating system, device manufacturer, etc. Similarly, the executable code may be implemented at least partially via one or more application programming interfaces (APIs) that facilitate cross-ecosystem access. Interactions performed via the various platforms may be compatible with interactions performed via a dedicated application for interacting with the spatial computing scheme, etc. For example, interactions (e.g., edits, manipulations, or other changes) performed via an Internet browser may be viewable and further modifiable via a dedicated application for interacting with the spatial computing scheme, and vice versa. Similarly, interactions performed via a dedicated application for interacting with the spatial computing scheme that is implemented on a desktop or laptop device may be viewable and further modifiable via a dedicated application for interacting with the spatial computing scheme that is implemented on a mobile device, and vice versa. In at least some examples, a device on which a user accesses a 3D spatial map does not have to be located in a physical environment represented by the 3D spatial map to allow the user to manipulate or otherwise interact with the 3D spatial map.

In at least some examples, the spatial computing scheme includes one or more spatial augmentation layers (SALs). Each SAL may be based on one or more 3D spatial maps. For example, a 3D spatial map in a particular location may be used to form multiple SALs. Each SAL may have particular permissions and may be uniquely viewable. For example, the spatial computing scheme may include a single-user SAL, a multi-user shared SAL, and a global SAL. In at least some implementations, only one SAL may be presented, interacted with, and/or displayed on a screen or viewfinder of a device at a time. For example, a user may not view and/or interact with more than one SAL at a time on a single device. In other examples, multiple SALs may be presented, interacted with, and/or displayed on a screen or viewfinder of a device at a time. For example, a user may layer SALs to view and/or interact with more than one SAL at a time on a single device. Alternatively, multiple SALs may be automatically presented and layered and a user may choose which of the SALs to interact with. In yet other examples, while viewing and interacting with one SAL, the user may also interact with another SAL. For example, the user may specify a setting or preference for an augmentation applied in one SAL to also apply to another SAL (e.g., a user may place a digital AR element in the single-user SAL and specify that the digital AR element also be present at the same location in the multi-user shared SAL, etc.).

To facilitate creation of the 3D spatial map, the executable code executing on a user device, or accessed by an application (native or web) executing on the user device may capture simultaneous localization and mapping (SLAM) data about a physical environment in which the user device is located. For example, the user device may be a SLAM capable device, such as a smartphone, tablet, or other device having light detection and ranging (LIDAR) functionality, radar functionality, a camera, or any other sensors or components that enable the SLAM capable device of generating data representative of a 3D space (e.g., the physical environment in which the SLAM capable device is located). Such data capture may be performed according to any suitable means for 3D spatial data capture, the scope of which is not limited herein. In at least some examples, the data capture is performed at least in part according to, or using, ARKIT by APPLE or ARCORE by GOOGLE. The data may form the basis for the 3D spatial map of the environment in which the SLAM capable device is located and which has been scanned or otherwise processed by the SLAM capable device to generate the data. The 3D spatial map is, in at least some examples, a map of a space that was scanned by the SLAM capable device, such as a room of a home, multiple rooms of a home, areas of a retail environment, etc., formed by one or more 3D meshes or mesh objects. The 3D spatial map may form the basis for the SALs, such as by facilitating AR or digital augmentations to be added to the SAL and positioned based on elements appearing in the physical environment and digitally represented in the 3D spatial map relative to those elements appearing in the physical environment. In examples in which a SAL includes some spatial data provided by a user, as well as other spatial data provided by other users, the spatial data provided by a user who is viewing the SAL may be displayed differently (such as in a different color) than spatial data in the SAL that is provided by other users. In at least some examples, while an application implemented according, at least in part, to the executable code of the spatial computing scheme is executing on the user device, the user device may be capturing data to create, expand, refine, or otherwise alter the 3D spatial map.

In some examples, the 3D spatial map may be displayed via an interface of the user device, such as presented by an application implemented at least partially according to the executable code of the spatial computing scheme. The 3D spatial map may be displayed in a point-of-view (POV) format in which the 3D spatial map is viewed from a perspective of the user device. The 3D spatial map may also be displayed as a Bird's Eye View. The Bird's Eye View may enable a user to view the 3D spatial map as a live, digital representation (e.g., via 3D mesh objects) of the physical environment in which a user is located. The Bird's Eye View may also enable the user to view the 3D spatial map as a live, digital representation (e.g., via 3D mesh objects) of a physical environment in which the user is not located, but for which the 3D spatial map has previously been generated, or is being generated. In at least some examples, the Bird's Eye View of the 3D spatial map may be a top-down view, or other user-defined view, of the 3D spatial map.

In at least some examples, the Bird's Eye View of the 3D spatial map enables a user who is scanning a physical environment to form the 3D spatial map to quickly reference the Bird's Eye View of the 3D spatial map to determine completeness of the 3D spatial map. In at least some examples, a user viewing the Bird's Eye View of the 3D spatial map, whether within the physical environment represented by the 3D spatial map or not within the physical environment represented by the 3D spatial map, may edit the 3D spatial map. For example, the user may augment, modify, or otherwise interact with one or more meshes that make up the 3D spatial map. As described above, a user may access the Bird's Eye View of the 3D spatial map cross-platform and cross-device. For example, the Bird's Eye View of the 3D spatial map may be accessed by the user via a web browser of a device that is/was not involved in capturing SLAM data to form the 3D spatial map and/or may not be located in the physical environment represented by the 3D spatial map. For example, in at least one implementation a user who is away from home may access the 3D spatial map remotely via the Bird's Eye View of the 3D spatial map and may add digital content to the 3D spatial map and/or modify or remove digital content already present in the 3D spatial map. For example, the user, via the Bird's Eye View of the 3D spatial map, may redecorate a home of the user represented by the 3D spatial map using digital content (e.g., such as AR elements) that other users located in the home of the user may view through an application that enables viewing of, or interacting with, the 3D spatial map.

The Bird's Eye View of the 3D spatial map may further enable a user to interact with, or provide some amount of control over, spatially-aware devices. For example, via the Bird's Eye View of the 3D spatial map, a user may define, view, edit, or control live, a drive path for a home robotics device (e.g., such as a robotic vacuum, robotic mop, etc.) to traverse in the physical environment represented by the 3D spatial map. In some examples, the user may view a programmed drive path for the home robotics device via the Bird's Eye View of the 3D spatial map, while in other examples the user may view a live drive path of the home robotics device Bird's Eye View of the 3D spatial map, for example, such that the user may see a substantially real-time location of the home robotics device and a path that it has taken, is taking, and/or will be taking. As described above, such interaction may be performed while in the physical environment represented by the 3D spatial map or while remote to the physical environment represented by the 3D spatial map.

In another example, a 3D spatial map representing a retail environment may be formed. A user may view the Bird's Eye View of the 3D spatial map representing the retail environment, and in doing so view digital content placed in the 3D spatial map and/or a substantially real time location and/or orientation within the retail environment of customers and/or staff who have granted permission for the sharing of such information (e.g., such as by connecting to a spatial computing system of the retail environment). The Bird's Eye View of the 3D spatial map may enable viewing of digital content associated with the retail environment in combination with the positions of customers in the retail environment. The Bird's Eye View of the 3D spatial map may also enable a user, such as a manager of the retail environment, to view interactions by customers with the digital content. In some examples, these interactions are elements of a sales transaction. The retail environment may be represented in multiple layers, or SALs, such that certain viewable information may selectively be enabled or disabled for convenience in viewing the Bird's Eye View of the 3D spatial map.

In other examples, users active in an AR environment may view one or more other users also active in the SAL via the Bird's Eye View of the 3D spatial map, such as while participating in a shared experience, a shared or multiplayer game, etc., such as via a global SAL and/or a multi-user shared SAL, as described above. In at least some examples, the Bird's Eye View of the 3D spatial map may include multiple layers such that certain viewable features may be selectively enabled or disabled. In some examples, the multiple layers are, or include, multiple SALs. In other examples, multiple layers may exist within a single SAL.

In another example, the Bird's Eye View of the 3D spatial map may enable a user to freely move about an AR environment constructed according to the 3D spatial map. As opposed to a point-of-view perspective, the Bird's Eye View of the 3D spatial map may provide a user with a top down, or other more expansive, view that enables a user to zoom in or zoom out on the 3D spatial map to view the 3D spatial map at varying degrees of granularity. While viewing the Bird's Eye View of the 3D spatial map the user may move freely about the AR environment and add, edit, or remove digital (e.g., AR) content within the AR environment. While viewing the Bird's Eye View of the 3D spatial map the user may also interact with AR content, such as selecting and/or engaging an AR hyperlink or other interactive element, at least some of which may direct the user to a website or other network addressed location. While viewing the Bird's Eye View of the 3D spatial map, a user may selectively enable or disable viewing of varying SALs, as described above herein.

In some examples, the Bird's Eye View of the 3D spatial map may be static, such as a snapshot of the 3D spatial map taken at a particular time. In other examples, as described elsewhere herein, the Bird's Eye View of the 3D spatial map may update in substantially real-time, such as to show changes to one or more mesh objects of the 3D spatial map, digital content in the 3D spatial map, users represented in the 3D spatial map, etc.

Manipulations to the 3D spatial map, whether to the 3D mesh objects that form the 3D spatial map or to digital content that augments the 3D spatial map, may be viewable in substantially real time to all users viewing the 3D spatial map. For example, manipulations made by a user physically present in the physical environment represented by the 3D spatial map may be viewable in substantially real time to users not physically present in the physical environment represented by the 3D spatial map but instead viewing the Bird's Eye View of the 3D spatial map remotely. Similarly, manipulations made by a user not physically present in the physical environment represented by the 3D spatial map but instead viewing the Bird's Eye View of the 3D spatial map remotely may be viewable in substantially real time to users physically present in the physical environment represented by the 3D spatial map.

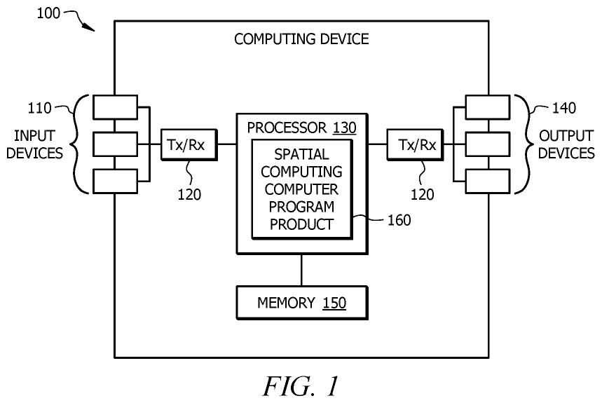

Referring now to FIG. 1, a block diagram of an example computing device 100 is shown. Computing device 100 is any suitable processing device capable of performing the functions disclosed herein such as a user device, a processing device, a user equipment, a smartphone, a wearable computing device, a tablet computing device, an Internet of Things (IoT) device, a computer system, a server, a computing resource, a cloud-computing node or device, a spatial computing hub, a SLAM capable device, etc. Computing device 100 is configured to implement at least some of the features disclosed herein, for example, the spatially aware computing or spatial computing scheme described herein, including the capturing of 3D spatial data, the creation, storing, and/or hosting of a SAL, presenting an application to a user to create an AR environment, creating, editing, displaying, and/or interacting with digital elements in a SAL, displaying, editing, manipulating, and/or otherwise interacting with a Bird's Eye View of a 3D spatial map of a physical environment (local or remote to the physical environment), etc. In various embodiments, for instance, the features of this disclosure are implemented using hardware, firmware, and/or software (e.g., such as software modules) installed to run on hardware. In some embodiments, the software utilizes one or more software development kits (SDKs) or SDK functions to perform at least some of the features/methods of this disclosure.

In some examples, the computing device 100 is an all-in-one device that performs each of the aforementioned operations of the present disclosure, or the computing device 100 is a node that performs any one or more, or portion of one or more, of the aforementioned operations. In one embodiment, the computing device 100 is an apparatus and/or system configured to implement a spatially aware computing environment, according to a computer program product executed on, or by, at least one processor.

The computing device 100 comprises one or more input devices 110. Some of the input devices 110 include at least some of cameras, magnetic sensors, temperature sensors, pressure sensors, accelerometers, microphones, keyboards, touchscreens, buttons, toggle switches, and/or other devices that allow a user to interact with, and/or provide input actively or passively to, the computing device 100. Some other of the input devices 110 are downstream ports coupled to a transceiver (Tx/Rx) 120, which are transmitters, receivers, or combinations thereof. The Tx/Rx 120 transmits and/or receives data to and/or from other computing or electronic devices via at least some of the input devices 110. Similarly, the computing device 100 comprises a plurality of output devices 140. Some of the output devices 140 include at least some of speakers, a display screen (which, in some examples, is also an input device such as a touchscreen), lights, or any other device that allows a user to interact with, and receive output from, the computing device 100. At least some of the output devices 140 are upstream ports coupled to another Tx/Rx 120, wherein the Tx/Rx 120 transmits and/or receives data from other nodes via the upstream ports. The downstream ports and/or the upstream ports include electrical and/or optical transmitting and/or receiving components. In another embodiment, the computing device 100 comprises one or more antennas (not shown) coupled to the Tx/Rx 120. In yet other embodiments, the computing device 100 includes additional Tx/Rx 120 such that the computing device 100 has multiple networking or communication interfaces, for example, such that the computing device 100 communicates with a first device using a first communication interface (e.g., such as via the Internet) and communicates with a second device using a second communication interface (e.g., such as another computing device 100 without using the Internet).

A processor 130 is coupled to the Tx/Rx 120 and at least some of the input devices 110 and/or output devices 140 and is configured to implement the spatial computing environment. In an embodiment, the processor 130 comprises one or more multi-core processors and/or memory modules 150, which functions as data stores, buffers, etc. The processor 130 is implemented as a general processor or as part of one or more application specific integrated circuits (ASICs), field-programmable gate arrays (FPGAs), and/or digital signal processors (DSPs). Although illustrated as a single processor, the processor 130 is not so limited and alternatively comprises multiple processors. The processor 130 further comprises processing logic configured to execute a spatial computing computer program product 160 that is configured to perform spatial computing and/or implement the spatial computing scheme (e.g., such as capturing of data to form a 3D spatial map, editing, displaying, and/or otherwise interacting with a Bird's Eye View of a 3D spatial map, etc.) as described herein.

FIG. 1 also illustrates that a memory module 150 is coupled to the processor 130 and is a non-transitory medium configured to store various types of data. Memory module 150 comprises memory devices including secondary storage, read-only memory (ROM), and random access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage is used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 150 houses the instructions for carrying out the various embodiments described herein. For example, the memory module 150 comprises the spatial computing computer program product 160, which is executed by processor 130.

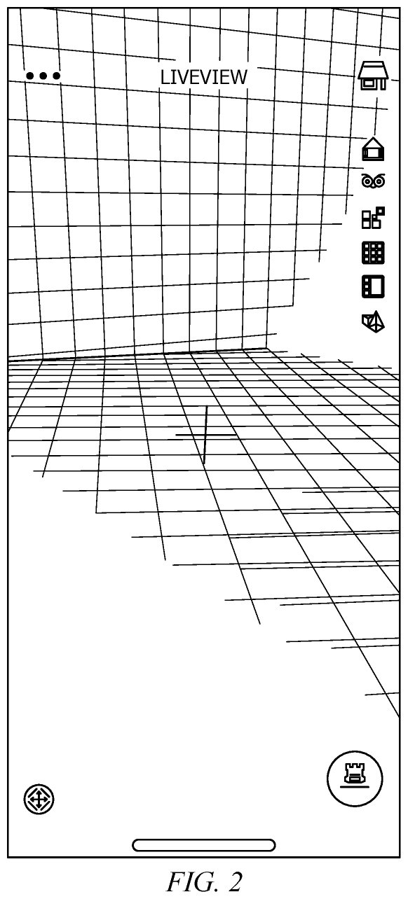

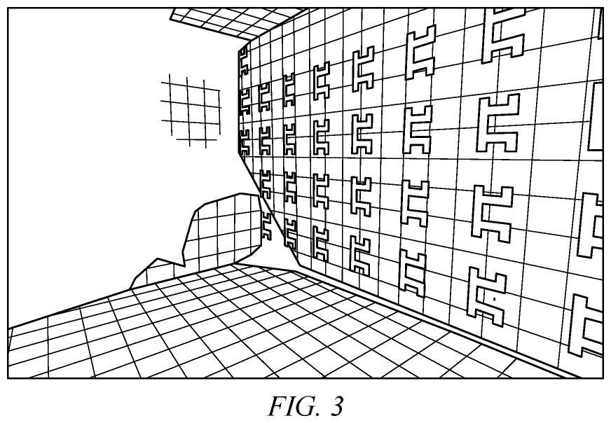

Referring now to FIGS. 2 and 3, graphical user interface (GUI) representations of a Bird's Eye View of a 3D spatial map are shown. In at least some examples, the 3D spatial map represented in FIGS. 2 and 3 is shown on a user device that is physically present in a physical environment represented by the 3D spatial map. In other examples, the 3D spatial map represented in FIGS. 2 and 3 is shown on a user device that is not physically present in a physical environment represented by the 3D spatial map. In either example, the user device may or may not be a SLAM capable device that captured data of the physical environment to form the 3D spatial data. The user device may be a computing device such as the computing device 100, described above with respect to FIG. 1.

As shown in FIGS. 2 and 3, mesh objects that form the 3D spatial map are illustrated as planes having grid lines. Areas shown in FIGS. 2 and 3 that lack grid lines, in at least some examples, are gaps in the 3D spatial map for which data representing the physical environment is unavailable. In some examples, the 3D spatial map shown in FIGS. 2 and 3 is shown in a web browser. In other examples, the 3D spatial map shown in FIGS. 2 and 3 is shown in a native application that is purpose built for use in the spatial computing scheme.

At least some aspects of this description may be further understood with reference to U.S. Provisional Patent Application No. 62/990,059, filed on Mar. 16, 2020 and titled “System and Method for Sensory Augmentation Including a Hub Device,” U.S. Provisional Patent Application No. 63/083,864, filed on Sep. 26, 2020 and titled “Spatially Aware Computing Hub and Environment,” U.S. Provisional Patent Application No. 63/127,532, filed on Dec. 18, 2020 and titled “Spatially Aware Environment Relocalization,” and/or U.S. Provisional Patent Application No. 63/129,425, filed on Dec. 22, 2020 and titled “Spatially Aware Environment Interaction,” each of which is incorporated herein by reference in its entirety.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other intervening devices and/or connections. Unless otherwise stated, “about,” “approximately,” or “substantially” preceding a value means+/−10 percent of the stated value or reference.

What is claimed is:

1. An apparatus, comprising:
a memory storing computer executable instructions for implementing a spatially aware computing scheme; and
a processor coupled to the memory and configured to execute the executable instructions to:
access a three-dimensional (3D) spatial map that comprises a plurality of meshes to form a 3D digital representation of a physical environment;
display the 3D spatial map in a Bird's Eye View orientation; and
receive a manipulation to the 3D spatial map while displaying the 3D spatial map in the Bird's Eye View orientation.

2. The apparatus of claim 1, wherein the apparatus is not located in the physical environment.

3. The apparatus of claim 2, wherein the manipulation is performed to the 3D spatial map by the apparatus and viewable by a second apparatus in substantially real-time.

4. The apparatus of claim 2, wherein a change to the 3D spatial map is implemented by a second apparatus and is viewable by the apparatus in substantially real-time.

5. The apparatus of claim 1, wherein the 3D spatial map is created by a second apparatus that scans the physical environment to form the 3D spatial map.

6. The apparatus of claim 1, wherein the manipulation comprises a change to at least one of the plurality of meshes.

7. The apparatus of claim 1, wherein the manipulation comprises a modification to digital content placed in the 3D spatial map.

8. The apparatus of claim 1, wherein the manipulation comprises insertion of digital content into the 3D spatial map.

9. An apparatus, comprising:
a memory storing computer executable instructions for implementing a spatially aware computing scheme; and
a processor coupled to the memory and configured to execute the executable instructions to:
access a three-dimensional (3D) spatial map that comprises a plurality of meshes to form a 3D digital representation of a physical environment;
display the 3D spatial map in a Bird's Eye View orientation; and
display visual indicators in the 3D spatial map corresponding to positions of one or more user devices in the physical environment.

10. The apparatus of claim 9, wherein the positions include location and orientation information.

11. The apparatus of claim 9, wherein the physical environment is a retail environment and the visual indicators are representative of at least some customers present in the retail environment.

12. The apparatus of claim 11, wherein the visual indicators are presented and updated in substantially real-time.

13. The apparatus of claim 11, wherein the processor is further configured to display digital content in the Bird's Eye View of the 3D spatial content, the digital content representative of augmented reality content viewable by the customers.

14. The apparatus of claim 13, wherein at least some of the augmented reality content is capable of being interacted with by the customers.

15. The apparatus of claim 14, wherein the interaction is an element of a sales transaction.

16. The apparatus of claim 13, wherein the digital content is editable while viewed in the Bird's Eye View of the 3D spatial content.

17. An apparatus, comprising:
a memory storing computer executable instructions for implementing a spatially aware computing scheme; and
a processor coupled to the memory and configured to execute the executable instructions to:
access a three-dimensional (3D) spatial map that comprises a plurality of meshes to form a 3D digital representation of a physical environment;
display the 3D spatial map in a Bird's Eye View orientation;
receive, via a user-input interface of the apparatus, a control input for a spatially-aware device represented in the 3D spatial map; and
transmit the control input to control the spatially-aware device.

18. The apparatus of claim 17, wherein the spatially-aware device is a robotic device and the control input is an action to be performed by the robotic device.

19. The apparatus of claim 18, wherein the drive path includes a programmed path of the robotic device and a current location of the robotic device in the 3D spatial map on the programmed path.

20. The apparatus of claim 17, wherein the apparatus is located remote to the physical environment while receiving and transmitting the control input.
